(19) United States
(12) Patent Application Publication
(10) Pub. No.: US 2003/0147777 A1
(43) Pub. Date: Aug. 7, 2003

(54) Test composition and device for the determination of cyanuric acid in water

(76) Inventor: Vinay D. Ghanekar, Wilmington, DE (US)

Correspondence Address: J.W. Gipple, GIPPLE & HALE, P.O. Box 40513, Washington, DC, 20016, US

(21) Appl. No.: 10/052,882

(22) Filed: Jan. 23, 2002

(51) Int. Cl. G01N 21/77

(52) U.S. Cl. 422/56; 422/55; 436/164; 436/169; 436/163; 436/100

(57) ABSTRACT

A test composition and device are described for determining levels of cyanuric acid in water, especially water in swimming pools and spas. The invention is especially characterized by avoiding the use of melamine as part of the test composition.

### FIELD OF THE INVENTION

The present invention is directed to a composition and device for determining the concentration of cyanuric acid in water. The invention is specifically directed to a composition and device which avoid the use of melamine in determining cyanuric acid levels in water such as in swimming pools.

### BACKGROUND OF THE INVENTION

Chlorine is an effective and economical disinfectant for water used, for example, in swimming pools and spas. Although the use of chlorine is widespread, one known concern remains that the free residual chlorine is susceptible to destruction by exposure to the ultraviolet rays of sunlight e.g. in outdoor swimming pools. In order to minimize the loss of free residual chlorine, stabilizers are introduced in swimming pool water.

A stabilizer frequently used for this purpose is cyanuric acid; however, it is essential to measure the cyanuric acid concentration accurately in order to maintain an optimal concentration in the water. A very low concentration of cyanuric acid would mean result in stabilizing ability while a very high concentration of cyanuric acid can lower the chlorine efficiency of chlorine as a sanitizer.

A currently test method for cyanuric acid in aqueous solution employs a liquid reagent system containing melamine that results in the formation of a turbid solution. The turbidity of the solution is proportional to the cyanuric acid concentration. Alternatively, a colorimetric test strip method containing melamine is reported to react with cyanuric acid. Both the liquid test method as well as the test strip method use melamine as an active ingredient in the reagent composition to determine the concentration of cyanuric acid in water.

However, this test procedure using melamine, to determine cyanuric acid levels, has several disadvantages:

In the colorimetric test strip method, melamine can suppress color intensity by adding to the reaction pad of the test strip.

When melamine is used, the test procedure is more temperature sensitive, and a further source of contamination is introduced.

Accordingly, it is an object of the present invention to provide an improved and simplified test procedure for determining cyanuric acid levels in water without using melamine as a test reagent component.

### SUMMARY OF THE INVENTION

In accordance with the present invention, a composition and device are provided for determining the concentration of cyanuric acid in water. The device of the invention may include an absorbent matrix such as cellulose-based paper, glass fiber, or polyester on to which the indicator reagent composition is absorbed and then dried to form a solid reagent matrix. The composition of the invention is capable of reacting with cyanuric acid in water concentrations from 0-150 ppm to give a color change indicative of the concentration of the cyanuric acid present.

The indicator composition of the invention comprises:

A mixture of acid/base (pH) indicators that gives a color change in response to the change in pH which corresponds to the concentration of cyanuric acid in test sample solution.

An acid to adjust the composition pH in the range of 2.5 less than 5.0, for example, a mineral acid, such as hydrochloric acid.

A polymer stabilizer such as polyvinylpyrrolidone (PVP).

A suitable carrier matrix of bibulous material either natural or synthetic, such as absorbent paper.

The method of employing the invention comprises contacting a test solution with the composition of the invention, which may be a dried deposit on an absorbent matrix, then observing the resultant color change and comparing it with a standard index of colors at specific cyanuric acid concentrations to quantitatively determine the amount of cyanuric acid in a given aqueous sample.

It is important, in accordance with the invention, that the pH of the indicator composition, be adjusted to a range of about 2.5 to less than 5, in contrast with the range of 5 to 8 required in prior procedures using melamine.

While not being bound to a particular theory, it is believed that when cyanuric acid encounters a certain concentration of hydrogen ions on the test strip pad, specifically at pH 2.5 to less than 5, the value of the equilibrium constant representing the balance between the tautomers of cyanuric acid changes. This new equilibrium constant leads to a change in pH on the reaction pad of the test strip and the mixture of acid/base indicators responds with a color change.

### EXAMPLES OF EMBODIMENTS OF THE INVENTION

In accordance with the procedures described above, the following compositions were prepared and utilized on absorbent paper test strips to determine known cyanuric acid concentrations in water. The table summarizes the test results.

Example 1 illustrates a composition of Dipping solution in a pH range of 2.5 to less than 5.0.

| | |
|---|---|
| 0.5% Chlorophenol red | 2.0 ml |
| 1% Bromothynol Hue | 20.0 ml |
| 5% PVP | 100 ml |
| Dilute to 1L with deionized (DI) water | |

Example 2 illustrates a composition of Dipping solution in pH range of 2.5 to less than 5.0.

| | |
|---|---|
| 0.5% Chlorophenol red | 40.0 ml |
| 5% PVP | 100 ml |
| Dilute 1L with deionized (DI) water. | |

Example 3 illustrates a composition of Dipping solution in pH range of 2.5 to less than 5.0.

| | |
|---|---|
| 1% Bromothymol blue | 20.0 ml |
| 5% PVP | 100 ml |
| Dilute to 1L with deionized (DI) water. | |

Example 4 illustrates a composition of Dipping solution in a pH range of 2.5 to less than 5.0.

| | |
|---|---|
| 0.5% Chlorophenol red | 10.0 mL |
| 1% Bromothymol blue | 15.0 mL |
| 5% PVP | 100 mL |
| Dilute to 1L with deionized (DI) water. | |

| Concentration | Test strip | Test strip | Test strip | Test strip |
|---|---|---|---|---|
| ppm | colors | colors | colors | colors |
| Cyanuric acid | Example 1 | Example 2 | Example 3 | Example 4 |
| 0 | yellow | yellow | yellow | mustard |
| 50 | pea green | peachy | pea green | dull green |
| | | yellow | | |
| 100 | avocado green | peach | avocado | olive green |
| | | | green | |
| 150 | bluish green | pink | bluish | army green |

While a preferred embodiment of the instant invention has been herein described, it will be understood that other embodiments and alternatives are considered to fall within the scope of the invention as defined in the claims. It will, for example, be appreciated by those of ordinary skill in the art that various colorgraphic procedures can be employed to quantify color changes in the test device and composition. It will also be understood that various alternative buffers, polymers, and indicators can be employed without departing from the intended scope of the invention.

What is claimed is:

1. A reagent composition for the determination of the concentration of cyanuric acid in water consisting essentially of an indicator or mixture of indicators which changes color in response to a change in the pH of the water proportional to the cyanuric acid concentration due to a shift in the equilibrium of the tautomers of the cyanuric acid present, the composition being adjusted to a pH of from about 2.5 to less than 5.

2. The reagent composition of claim 1 which further includes a stabilizing polymer.

3. The reagent composition of claim 1 wherein said indicator is selected from one or more of chlorophenol red and bromothymol blue.

4. The reagent composition of claim 3 wherein the pH of said indicator is adjusted with a mineral acid.

5. The reagent composition of claim 2 wherein said stabilizing polymer is polyvinylpyrrolidone.

6. A test device for determining the concentration of cyanuric acid in water comprising a porous matrix containing a reagent composition adjusted to a pH of about 2.5 to less than 5 and consisting essentially of a pH indicator which changes color in response to a change in the pH in the environment of the matrix when the said matrix is contacted with said water containing cyanuric acid.

7. The test device of claim 6 wherein said porous matrix is a bibulous material.

8. The test device of claim 6 wherein said indicator is selected from one or more of chlorophenol red and bromothymol blue.

9. The test device of claim 6 wherein the pH of said indicator is adjusted with a mineral acid.

10. The test device of claim 6 wherein said reagent composition further includes a stabilizing polymer.

11. The test device of claim 10 wherein said stabilizing polymer is polyvinylpyrrolidone.
